(19) United States
(12) Patent Application Publication
(10) Pub. No.: US 2020/0034576 A1
(43) Pub. Date: Jan. 30, 2020

(54) SYSTEM, METHOD, AND APPARATUS FOR DETERMINING INTRUSION

(71) Applicant: Ragnar Labs Inc., Seattle, WA (US)

(72) Inventors: Tim Etchells, Seattle, WA (US); Alexander Lebedev, Seattle, WA (US)

(73) Assignee: Ragnar Labs Inc., Seattle, WA (US)

(21) Appl. No.: 16/520,913

(22) Filed: Jul. 24, 2019

Related U.S. Application Data
(60) Provisional application No. 62/703,530, filed on Jul. 26, 2018.

(51) Int. Cl. G06F 21/86

(52) U.S. Cl. CPC G06F 21/86

(57) ABSTRACT

A method is disclosed. The method includes providing power to a device including a housing, determining an initial impedance at a first time between a first location of the housing and a second location of the housing, measuring a measured impedance at a second time following the first time between the first location of the housing and the second location of the housing, comparing the measured impedance to the initial impedance, and initiating a breach action if the measured impedance is not substantially equal to the initial impedance. A power interruption to the device occurs between the first time and the second time. Measuring the measured impedance includes using a swept voltage or a swept current source.

### CROSS-REFERENCE TO RELATED APPLICATIONS

This application claims the benefit of the following provisional application: 62/703,530 filed Jul. 26, 2018, the entire disclosure of which is incorporated herein by reference.

### TECHNICAL FIELD

The present disclosure is directed to a system and method for determining intrusion after a power interruption.

### BACKGROUND OF THE DISCLOSURE

Design of trusted devices, hardware security modules, cryptographic currency wallets or similar devices typically involves processes for securing or destroying key material or other data in the event of physical tampering. Conventional devices often include elements such as, for example, physical elements e.g. (mask layers and UV detectors) and software to secure data.

Once physical access to the internal components of a device has been achieved, it becomes relatively easy for an attacker to monitor communication paths and to determine an attack vector.

Methods such as potting may help in making access harder, but attacks remain possible. Other protective methods may include seals, active circuits or loops similar to conventional alarm systems.

While breaking a circuit is a known, conventional technique for detecting tampering in alarm systems, mobile devices generally have a vulnerability in that they are not able to monitor a circuit when the device is powered off. For example, an attacker may deliberately allow a battery of a mobile device to discharge. The device may then be opened, the monitor circuit shorted out, and then the battery may be recharged. In this case, the device processor may not be able to detect any record or indication that an attack has happened.

The exemplary disclosed system and method of the present disclosure is directed to overcoming one or more of the shortcomings set forth above and/or other deficiencies in existing technology.

### SUMMARY OF THE DISCLOSURE

In one exemplary aspect, the present disclosure is directed to a method. The method includes providing power to a device including a housing, determining an initial impedance at a first time between a first location of the housing and a second location of the housing, measuring a measured impedance at a second time following the first time between the first location of the housing and the second location of the housing, comparing the measured impedance to the initial impedance, and initiating a breach action if the measured impedance is not substantially equal to the initial impedance. A power interruption to the device occurs between the first time and the second time. Measuring the measured impedance includes using a swept voltage or a swept current source.

In another aspect, the present disclosure is directed to an apparatus. The apparatus includes a device configured to be powered, the device including a housing, a controller, an impedance sensor controlled by the controller, the impedance sensor configured to measure a measured impedance between a first location of the housing and a second location of the housing, and a swept current source. The controller is configured to compare the measured impedance with a predetermined impedance between the first location and the second location. The controller is configured to initiate a breach action if the measured impedance is not substantially equal to the predetermined impedance. The controller is configured to control the impedance sensor to measure the measured impedance at a plurality of frequencies using the swept current source.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a schematic illustration of an exemplary system, in accordance with at least some exemplary embodiments of the present disclosure;

FIG. 2 is a schematic illustration of an exemplary system, in accordance with at least some exemplary embodiments of the present disclosure;

FIG. 3 is a sectional illustration of an exemplary system, in accordance with at least some exemplary embodiments of the present disclosure;

FIG. 4 is a schematic illustration of an exemplary system, in accordance with at least some exemplary embodiments of the present disclosure;

FIG. 5 is a flowchart illustration of an exemplary process, in accordance with at least some exemplary embodiments of the present disclosure;

FIG. 6 is a schematic illustration of an exemplary computing device, in accordance with at least some exemplary embodiments of the present disclosure; and

FIG. 7 is a schematic illustration of an exemplary network, in accordance with at least some exemplary embodiments of the present disclosure.

### DETAILED DESCRIPTION AND INDUSTRIAL APPLICABILITY

At least some exemplary embodiments of the present disclosure relate generally to a case impedance measurement apparatus that may help to determine intrusion during or after a power interruption (e.g., shutting down a power source or battery or other form of power removal). For example, the exemplary disclosed device may use an impedance of a housing (e.g., a case) as part of an anti-tamper mechanism. The exemplary disclosed device may use a change (e.g., a break) in impedance to recognize housing (e.g., case) intrusion. For example, the exemplary disclosed device may actively provide (e.g., inject) an AC or DC current through a conductive housing (e.g., case) and measure the current returning at one or more locations to make a determination regarding the properties of the signal path. The exemplary disclosed system may store the determined properties as an impedance profile, and then use the stored impedance profile to determine if a change has been made following a power interruption.

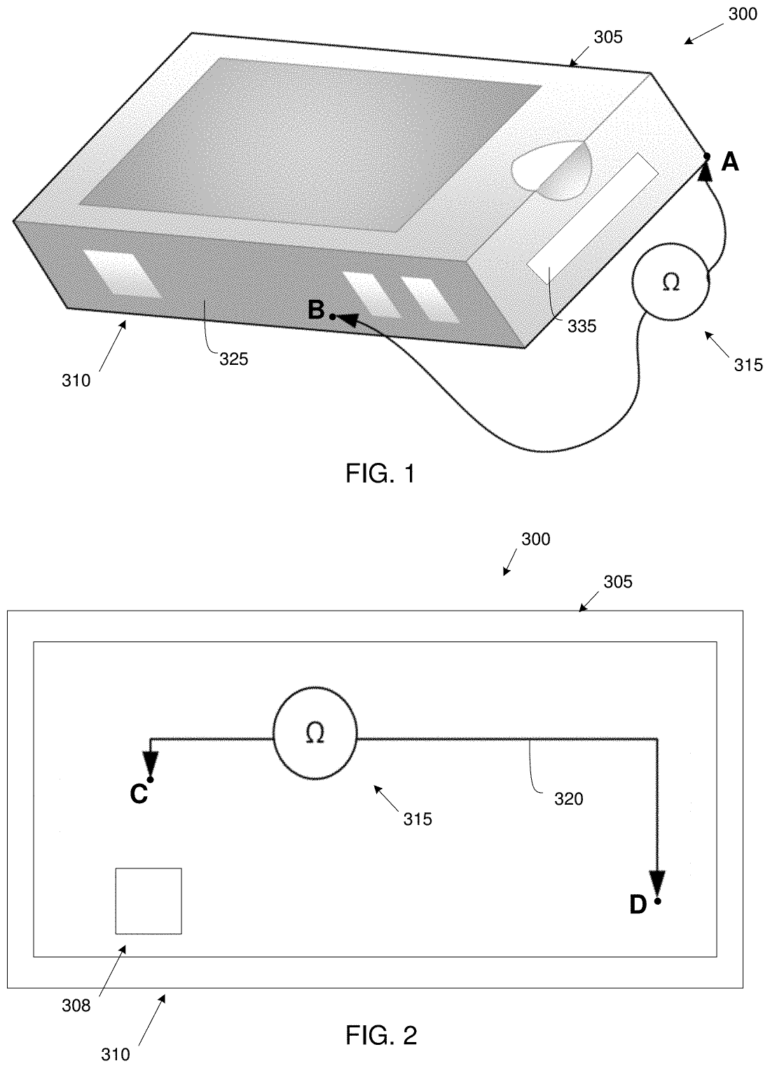

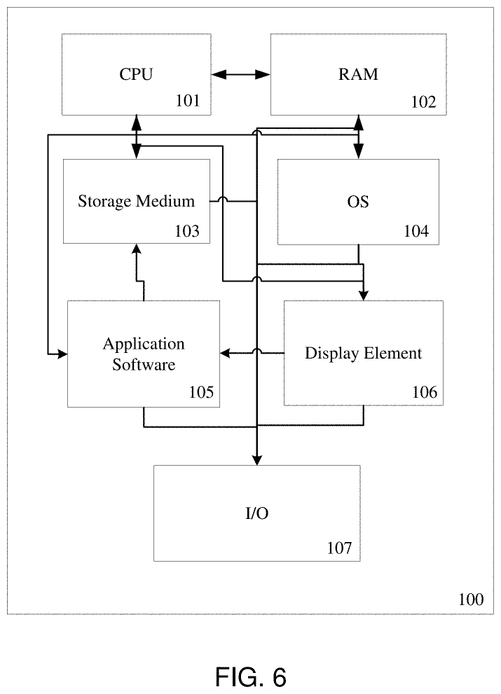

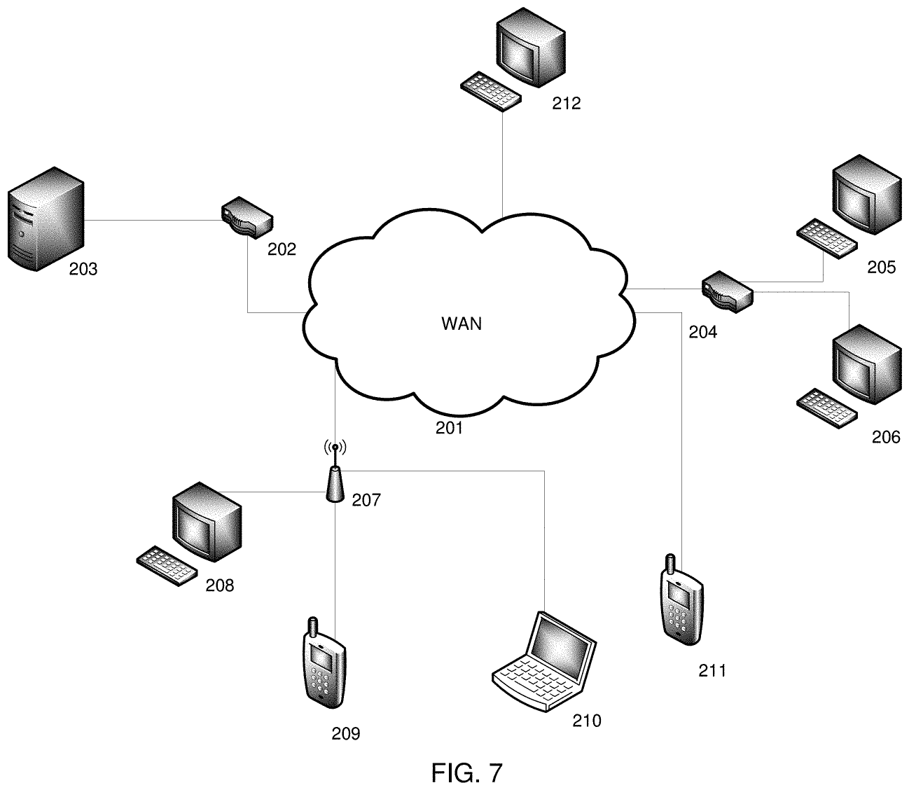

FIGS. 1 and 2 illustrate an exemplary system 300 of the present disclosure. For example as disclosed further below, FIG. 1 illustrates an example of measurement locations, and FIG. 2 illustrates an example of internal measurement of an exemplary device of system 300. System 300 may include computing components similar to those described below regarding FIG. 6, and may be part of or in communication with an exemplary network that may be similar to the exemplary network of FIG. 7. For example, system 300 may have controller components including a processor that may detect an intrusion to system 300 as disclosed for example herein. System 300 may also include components such as storage components and/or storage media that may store data indicating unique characteristics of system 300 (e.g., housing or case characteristics) as disclosed herein.

System 300 may for example include a controller 308 for controlling an operation of components of a device 305. Controller 308 may include for example a micro-processing logic control device or board components. Also for example, controller 308 may include input/output arrangements that allow it to be connected (e.g., via wireless and/or electrical connection) to other components of system 300 (e.g., components of device 305). For example, controller 308 may communicate with components of system 300 via wireless communication and/or via electrical lines (e.g., electrical line communication to a sensor and/or other components of device 305 as described for example below). For example, controller 308 may control device 305 to act as an Internet of Things (IoT) device that may provide data to and/or be controlled by system 300 as a data-providing device.

System 300 may include device 305 having a housing 310. Device 305 may be any suitable device including components configured to substantially prevent intrusion such as, for example, a mobile device such as a phone or tablet, any suitable computing device, a tamper-proof electronic seal, a secure device such as a device for containing sensitive information, and/or any other device including information (e.g., information to be protected). Housing 310 may be for example a case containing components of device 305.

Housing 310 may be any suitable structural assembly for containing and/or attachment of components of system 300. For example, housing 310 may be a structural assembly having any suitable shape (e.g., rectangular prism, cylindrical, cubic, and/or any other suitable shape) and including one or more cavities for containing components of system 300. Housing 310 may also be any suitable housing for protecting components of system 300 from the elements (e.g., precipitation, wind, exposure to heat and light, and/or any other environmental or manmade effects), and/or sealing interior cavities of housing 310 against the intrusion of debris and/or other undesirable material. Housing 310 (e.g., as well as other components of system 300) may be formed from any suitable materials for containing, protecting, and/or sealing components of system 300 such as, for example, polymer material, structural metal (e.g., structural steel), co-polymer material, thermoplastic and thermosetting polymers, resin-containing material, polyethylene, polystyrene, polypropylene, epoxy resins, phenolic resins, Acrylanitrile Butadiene Styrene (ABS), Polycarbonate (PC), Mix of ABS and PC, Acetal (POM), Acetate, Acrylic (PMMA), Liquid Crystal Polymer (LCP), Mylar, Polyamid-Nylon, Polyamid-Nylon 6, Polyamid-Nylon 11, Polybutylene Terephthalate (PBT), Polycarbonate (PC), Polyetherimide (PEI), Polyethylene (PE), Low Density PE (LDPE), High Density PE (HDPE), Ultra High Molecular Weight PE (UHMW PE), Polyethylene Terephthalate (PET), PolPolypropylene (PP), Polyphthalamide (PPA), Polyphenylenesulfide (PPS), Polystyrene (PS), High Impact Polystyrene (HIPS), Polysulfone (PSU), Polyurethane (PU), Polyvinyl Chloride (PVC), Chlorinated Polyvinyl chloride (CPVC), Polyvinylidenefluoride (PVDF), Styrene Acrylonitrile (SAN), Teflon TFE, Thermoplastic Elastomer (TPE), Thermoplastic Polyurethane (TPU), and/or Engineered Thermoplastic Polyurethane (ETPU), or any suitable combination thereof.

Housing 310 may be formed to have an impedance (e.g., electrical impedance) of a desired or predetermined value or range. For example, housing 310 may be formed to have a desired or predetermined impedance between two or more locations or points of housing 310 (e.g., between two points A and B disposed at an exterior surface portion of housing 310 as illustrated in FIG. 1, and/or between two points C and D disposed within an exterior or interior portion of housing 310 as illustrated in FIG. 2). For example, the effective resistance of components of housing 310 disposed between points A and B (e.g., or between points C and D) to current may be any desired and/or predetermined value or range (e.g., or between any of internal or external points A, B, C, and D). For example, the components of housing 310 may be configured to provide any desired cumulative effect of reactance and/or resistance. Points A and B may be substantially the same points and/or substantially different points than points C and D, respectively. For example, each of points A, B, C, and D may be a point disposed at an exterior surface portion (e.g., at a surface portion of housing 310) or at an interior portion of device 305. As disclosed for example herein, the system 300 may include one or more components that provide an AC or DC current through conductive housing 310 and measure the current returning at one or more locations (e.g., points A, B, C, and/or D) to make a determination regarding the properties of the signal path.

Any suitable device may be used to measure effective resistance (e.g., between points A and B, between points C and D, and/or between any other exemplary disclosed points). For example as schematically illustrated in FIGS. 1 and 2, a sensor 315 may be fixedly or removably attached to device 305 (e.g., or partially or substantially entirely integrated with device 305 as a partially or substantially entirely integrated sensor). Sensor 315 may sense current, voltage, and/or any other desired parameter at points A, B, C, and D (e.g., or any other exemplary disclosed points). For example, sensor 315 may provide an AC or DC current through or on housing 310 and measure current, voltage, and/or any other desired parameters at points A, B, C, and D (e.g., or any other exemplary disclosed locations or points). Sensor 315 may be any suitable sensing device for sensing the exemplary parameters such as, for example, a kelvin sensor (e.g., kelvin type sensor), a photodiode sensor, a piezoelectric sensor, a charge coupled sensor, a charge output sensors, and/or any other suitable type of sensor. Sensor 315 may be an optical sensor. Sensor 315 may also be a hall effect current sensor. In at least some exemplary embodiments, sensor 315 may be any suitable coil sensor such as a magnetic coil sensor. Sensor 315 may also be any suitable type of resistive sensor. Sensor 315 may be for example a two-wire sensor, a three-wire sensor, or a four-wire sensor.

Sensor 315 may be used with an AC voltage sweep. For example, sensor 315 may be used with a swept AC voltage or current source that may be driven to determine (e.g., look for) impedance variation at various frequencies across contact points (e.g., points A, B, C, D, and/or any other exemplary disclosed locations or points) and measure voltage or current (e.g., that is received by sensor 315). Sensor 315 may operate (e.g., with a sweeping AC voltage or current source) at a range of frequencies to create and/or build up an impedance profile of housing 310.

Sensor 315 may include one or more connection portions 320 that may be disposed between any of the exemplary disclosed points (e.g., between points A and B or between points C and D). One or more connection portions 320 may electrically connect the exemplary disclosed locations or points. Connection portions 320 may be maintained in place on housing 310 by any suitable technique. For example, connection portions 320 may be maintained in place on housing 310 via any suitable friction connector (e.g., pogo pins or a spring such as a leaf spring).

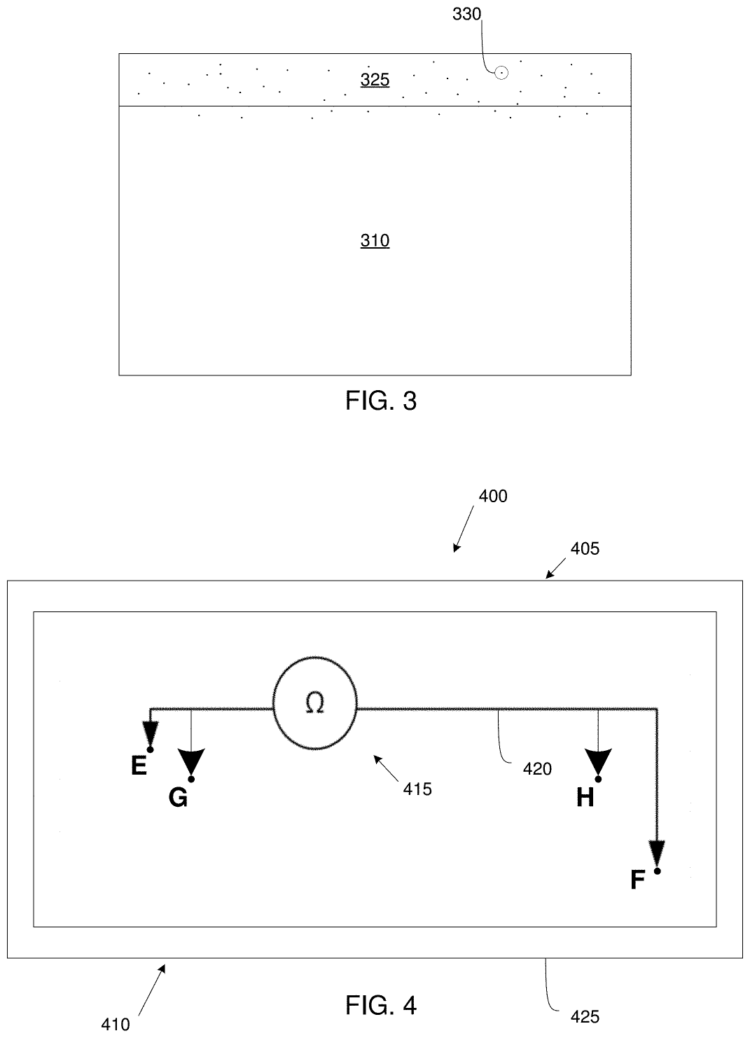

As illustrated in FIGS. 1 and 3 and in at least some exemplary embodiments, housing 310 may be coated with a coating 325 that provides an impedance of a desired or predetermined value or range. For example, coating 325 having a predetermined thickness (e.g., constant and/or variable portions of thickness) may be disposed on housing 310 between points A and B. Coating 325 may have any suitable thickness such as, for example, between about 1 μm and about 150 μm, between about 1 μm and about 100 μm, between about 1 μm and about 50 μm, between about 1 μm and about 20 μm, between about 2 μm and about 10 μm, or any other suitable thickness. Coating 325 may include one or more materials 330 having desired properties (e.g., formed from any suitable predetermined materials) and/or be configured in any desired substantially constant or variable thickness to provide a desired impedance value or range of values. In at least some exemplary embodiments, coating 325 and/or housing 310 may be doped (e.g., with materials 330) and/or subjected to any desired doping effect. Also for example, coating 325 may both coat and provide a doping effect to housing 310. Materials 330 may include for example carbon or copper material. For example, the thickness of coating 325 may be configured (e.g., modified) to provide an impedance within a certain range. Also for example, material 330 having predetermined properties may be partly or substantially entirely embedded in coating 325 to provide desired impedance characteristics. Also for example, the thickness of a wall portion of housing 310 (e.g., an exterior wall portion) and/or coating 325 may have a desired variable and/or constant thickness, be formed from predetermined materials, include embedded material, and/or be provided with predetermined coating 325 (e.g., as described above) to provide an overall impedance between measured locations or points (e.g., between any of points A, B, C, and D) of a desired or predetermined value or range of values.

In at least some exemplary embodiments, housing 310 may be coated with coating 325 that may be an electromagnetic interference (EMI) coating. For example, coating 325 may include carbon and/or copper. For example, coating 325 may be an EMI coating including carbon and/or copper. Also for example, coating 325 may be a spray coating such as an EMI spray coating. Coating 325 may also be a radio frequency interference (RFI) coating. Further for example, coating 325 may be an impregnated coating (e.g., such as a liquid-impregnated coating). Coating 325 may be a paint coating. In at least some exemplary embodiments, coating 325 may be a carbon or copper impregnated EMI paint coating. Coating 325 may be applied and/or configured to provide an impedance of a desired value and/or within a desired range (e.g., between any of points A, B, C, and D).

In at least some exemplary embodiments and as illustrated in FIG. 1, a layer 335 may be attached to housing 310. For example, layer 335 may be adhered to a surface of housing 310. Layer 335 may be a tape (e.g., adhesive tape) that is applied to a surface of housing 310. In at least some exemplary embodiments, layer 335 may include conductive and/or variable impedance tapes. Also for example, housing 310 may be both partially or substantially entirely coated with coating 325 described for example above and include layer 335 described for example above that may be attached (e.g., adhered) to a surface of housing 310 and/or a surface of coating 325. In at least some exemplary embodiments, layer 335 may be attached to a surface of housing 310 and coating 325 may be applied to a surface of layer 335.

The exemplary measurement locations or points (e.g., points between which impedance may be determined such as points A and B) may be on a same side of housing 310 or on different sides of housing 310. For example, the exemplary locations or points may be on adjacent sides (e.g., one on a front of device 305 and one on a side of device 305) or on opposite sides (e.g., one on a front of device 305 and one on a back of device 305) of device 305. System 300 may thereby measure an impedance between the locations or points (e.g., between any of points A, B, C, D, and any other suitable point disposed in or on device 305) that may be based on components of device 305 including housing 310, an exemplary coating disposed on housing 310, an exemplary layer disposed on housing 310, and/or any other component of device 305 and/or system 300 that may be disposed between the exemplary measurement locations or points.

FIG. 4 illustrates another exemplary embodiment of the exemplary disclosed system. System 400 may include a device 405, a housing 410, a sensor 415, a connection portion 420, and a coating 425 that may be generally similar to device 305, housing 310, sensor 315, connection portion 320, and coating 325. Sensor 415 may be any suitable four-wire sensor such as a kelvin type sensor. Sensor 415 may provide four-point measurement of impedance (e.g., effective resistance). Sensor 415 may provide current (e.g., or current may be provided to sensor 415) via points E and F that may be force connections. Impedance may be measured by sensor 415 between points G and H that may be voltage sensing connections. Sensor 415 may thereby provide current through or across device 405 (e.g., housing 410) to measure impedance between desired locations or points (e.g., points G and H).

In at least some exemplary embodiments, the exemplary disclosed apparatus may include a device (e.g., device 305 and/or device 405) configured to be powered, the device including a housing (e.g., housing 310 and/or housing 410), a controller, an impedance sensor (e.g., sensor 315 and/or sensor 415) controlled by the controller, the impedance sensor configured to measure a measured impedance between a first location of the housing and a second location of the housing, and a swept current source. The controller may be configured to compare the measured impedance with a predetermined impedance between the first location and the second location. The controller may be configured to initiate a breach action if the measured impedance is not substantially equal to the predetermined impedance. The controller may be configured to control the impedance sensor to measure the measured impedance at a plurality of frequencies using the swept current source. The impedance sensor may be a kelvin sensor. The impedance sensor may include a friction connector configured to maintain the impedance sensor in place on the housing. The friction connector may include a leaf spring or a plurality of pogo pins. The device may be a mobile device and the housing may be a mobile device case.

The exemplary disclosed system, apparatus, and method may be used in any suitable application for identifying intrusion into or breach of a device. For example, the exemplary disclosed system, apparatus, and method may be used in any suitable application for identifying intrusion into a device or other system that may be powered down or powered off. The exemplary disclosed system, apparatus, and method may be used in any suitable application involving protecting against intrusion into computing devices (e.g., mobile devices, desktop computers, laptops, tablets, and other computing devices), alarm systems, electrical stations such as kiosks, electrical locks, and/or any other suitable device (e.g., that may be powered down or off).

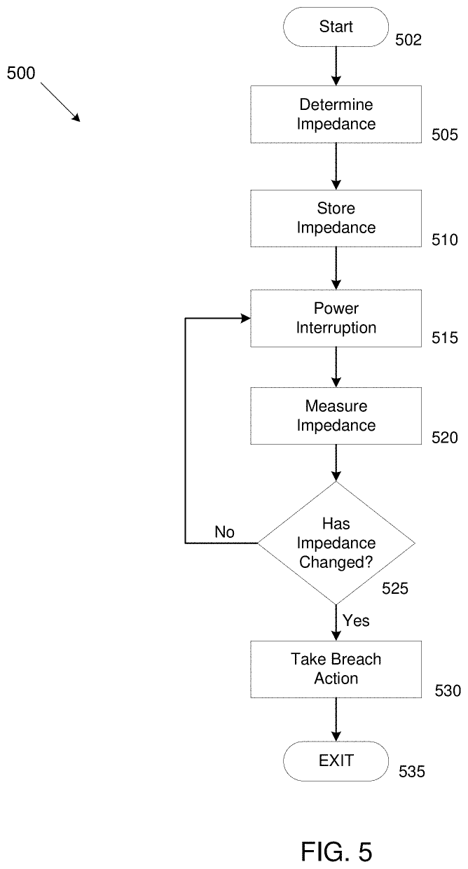

FIG. 5 illustrates an exemplary process 500 of the present disclosure. Process 500 may begin at step 502. At step 505, system 300 (e.g., or system 400) may determine an impedance between two predetermined locations or points (e.g., between points A and B, between points C and D, and/or between any of points A, B, C, D, and/or any other suitable internal or external point of device 305 or device 405). For example, system 300 (e.g., or system 400) may determine the impedance during or shortly after manufacture. For example, the impedance may be a predetermined value or range of values that have been determined for a given configuration of device 305 or device 405 (e.g., based on prior testing). Also for example, system 300 (e.g., or system 400) may determine an impedance at first turn-on (e.g., first power-up) following manufacturing and/or at any other desired times following manufacture and during a service life of system 300 or system 400. For example, system 300 (e.g., or system 400) may operate automatically at first turn-on to determine the impedance of housing 310 (e.g., or housing 410) between any of points A, B, C, D, and/or any other suitable internal or external point of device 305 or device 405. For example, this process may occur either at DC (e.g., DC voltage) and/or at some other discrete or range of frequencies to create and/or build up an impedance profile of housing 310 (e.g., the portion of housing 310 between points A and B, between points C and D, and/or between any of points A, B, C, D, and/or any other suitable internal or external location or point of device 305 or device 405).

At step 510, system 300 (e.g., or system 400) may store the impedance determined at step 505. For example, controller 308 may control data of the impedance to be stored in a data storage medium of the exemplary system. At step 515, device 305 or device 405 may undergo a power interruption. For example, device 305 (e.g., and/or all of system 300, e.g. or system 400) may be powered off, run out of battery power, and/or undergo any other type of change in power status during which an impedance (e.g., between points A and B, between points C and D, and/or between any of points A, B, C, D, and/or any other suitable internal or external point of device 305 or device 405) may not be monitored.

After the power interruption at step 515, device 305 (e.g., and/or all of system 300, e.g., or system 400) may be again powered on at step 520. System 300 may measure the impedance (e.g., between points A and B, between points C and D, and/or between any of points A, B, C, D, and/or any other suitable internal or external point of device 305 or device 405) at step 520. For example, the measurement may be stored as data, which may be transmitted and read by components of system 300 or system 400 (e.g., as described above regarding FIGS. 6 and 7, and/or such as a Micro controller/FPGA/SOIC) and used to determine if the case has been removed and replaced with a short or other such item. For example, system 300 (e.g., or system 400) may compare the impedance value or range measured or determined at step 505 and stored at step 510 with the impedance measured (e.g., and stored) at step 520. If the impedance is substantially equal (e.g., substantially the same), then system 300 (e.g., or system 400) may return to step 515 to await the next power interruption. The impedance values measured or determined at steps 505 and 520 may be substantially equal if they are substantially equal (e.g., the same or exactly the same as each other) or within a predetermined range of each other. For example, the impedance values obtained at steps 505 and 520 may be substantially equal if they are within an allowable error of measurement of sensor 315 or sensor 415 (e.g., a predetermined range or tolerance associated with a measurement accuracy or precision of sensor 315 or sensor 415) or any other suitable predetermined amount. For example, the impedance values obtained at steps 505 and 520 may be substantially equal if there is 1% or less difference between the values (e.g., or 2% or less or any other suitable threshold) for example as measured in ohms or any other suitable units or values. If the impedance values obtained at steps 505 and 520 are not substantially equal, system 300 or system 400 may initiate a breach action as described for example below.

At step 525, if the impedance has changed (e.g., the impedances measured at steps 505 and 520 are not substantially equal), then system 300 (e.g., or system 400) may proceed to step 530, in which one or more breach actions may be taken. For example, system 300 or system 400 may initiate a breach action at step 530. For example, an alert may be issued, data may be secured, data may be destroyed, and/or any other suitable action may be taken that may be based on the assumption that device 305 or device 405 has been attacked or breached. For example system 300 (e.g., or system 400) may take any suitable steps or initiate processes to secure or destroy data and/or to prevent access (e.g., prevent physical access and/or remote access to system 300 or other systems using device 305, e.g. or to system 400). For example, when device 305 (e.g., and/or system 300 or system 400) powers up, if the impedance at certain frequencies and/or DC does not fall within the value or range of values that were initially measured (e.g., at step 505 for example when the unit was first built), then system 300 (e.g., or system 400) may make a determination that device 305 or device 405 has been tampered with, breached, and/or attacked. For example, when the impedance is determined to have changed at step 525, system 300 (e.g., or system 400) may issue an alert at step 530 to indicate that the unique impedance characteristics of housing 310 (e.g., and/or any other part of device 305 or device 405) was changed because those portions were for example removed, replaced, modified, and/or destroyed in order to gain access to device 305 (e.g., a physical micro controller of device 305) or device 405. System 300 (e.g., or system 400) may also initiate processes to allow a check or other determination to verify that a breach has actually occurred, prior to destroying data. For example, system 300 (e.g., or system 400) may disable an operation of device 305 (e.g., or device 405), and then initiate a process for verifying a breach actually occurred, prior to destroying data (e.g., to make sure a breach of device 305 or device 405 actually in fact occurred before destroying and/or corrupting data or taking other similar action). Alternatively for example, system 300 (e.g., or system 400) may simply destroy data immediately, without a determination of whether a breach actually happened (e.g., before system 300 or system 400 proceeds to step 530). Process 500 may end at step 535.

In at least some exemplary embodiments, the exemplary disclosed method may include providing power to a device (e.g., device 305 and/or device 405) including a housing (e.g., housing 310 and/or housing 410), determining an initial impedance at a first time between a first location of the housing and a second location of the housing, measuring a measured impedance at a second time following the first time between the first location of the housing and the second location of the housing, comparing the measured impedance to the initial impedance, and initiating a breach action if the measured impedance is not substantially equal to the initial impedance. A power interruption to the device may occur between the first time and the second time. Measuring the measured impedance may include using a swept voltage or a swept current source. Using the swept voltage or the swept current source may include using a swept AC voltage or a swept AC current source. Measuring the measured impedance may include sensing a property of a coating disposed on the housing. The coating may be selected from the group consisting of an electromagnetic interference coating and a radio frequency interference coating. The coating may be an electromagnetic interference paint coating impregnated with a material selected from the group consisting of a carbon material or a copper material. Measuring the measured impedance may include sensing a property of an adhesive tape disposed on the housing. Measuring the measured impedance may include using a four-wire sensor. Determining the initial impedance may include using at least one predetermined impedance value based on a configuration of the device. Determining the initial impedance may include sensing the initial impedance at a first power-up of the device following manufacture. The breach action may be selected from the group consisting of issuing an alert to at least one user, securing data stored by the device, and destroying data stored by the device. Using the swept voltage or the swept current source may include using the swept voltage or the swept current source at a range of frequencies to create an impedance profile of the housing.

In at least some exemplary embodiments, the exemplary disclosed method may include providing power to a device (e.g., device 305 and/or device 405) including a housing (e.g., housing 310 and/or housing 410), determining an initial impedance at a first time between a first location of the housing and a second location of the housing, measuring a measured impedance at a second time following the first time between the first location of the housing and the second location of the housing, comparing the measured impedance to the initial impedance, and initiating a breach action if the measured impedance is not substantially equal to the initial impedance. A power interruption to the device may occur between the first time and the second time. Measuring the measured impedance may include using a swept AC voltage or a swept AC current source. Using the swept AC voltage or the swept AC current source may include using the swept AC voltage or the swept AC current source at a range of frequencies to create an impedance profile of the housing. Measuring the measured impedance may include sensing a property of a coating disposed on the housing. The coating may be selected from the group consisting of an electromagnetic interference coating and a radio frequency interference coating. The breach action may be selected from the group consisting of issuing an alert to at least one user of the device, securing data stored by the device, and destroying data stored by the device.

The exemplary disclosed system, apparatus, and method may provide an effective technique for detecting tampering in devices such as mobile devices. For example, the exemplary disclosed system, apparatus, and method may provide a technique for detecting tampering or intrusion into a device after the device has been powered off. The exemplary disclosed system, apparatus, and method may provide a record and/or indication that an attack, breach, and/or other intrusion into a device has occurred.

An illustrative representation of a computing device appropriate for use with embodiments of the system of the present disclosure is shown in FIG. 6. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 7, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 7, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 7, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A method, comprising:
providing power to a device including a housing;
determining an initial impedance at a first time between a first location of the housing and a second location of the housing;
measuring a measured impedance at a second time following the first time between the first location of the housing and the second location of the housing;
comparing the measured impedance to the initial impedance; and
initiating a breach action if the measured impedance is not substantially equal to the initial impedance;
wherein a power interruption to the device occurs between the first time and the second time; and
wherein measuring the measured impedance includes using a swept voltage or a swept current source.

2. The method of claim 1, wherein using the swept voltage or the swept current source includes using a swept AC voltage or a swept AC current source.

3. The method of claim 1, wherein measuring the measured impedance includes sensing a property of a coating disposed on the housing.

4. The method of claim 3, wherein the coating is selected from the group consisting of an electromagnetic interference coating and a radio frequency interference coating.

5. The method of claim 3, wherein the coating is an electromagnetic interference paint coating impregnated with a material selected from the group consisting of a carbon material and a copper material.

6. The method of claim 1, wherein measuring the measured impedance includes sensing a property of an adhesive tape disposed on the housing.

7. The method of claim 1, wherein measuring the measured impedance includes using a four-wire sensor.

8. The method of claim 1, wherein determining the initial impedance includes using at least one predetermined impedance value based on a configuration of the device.

9. The method of claim 1, wherein determining the initial impedance includes sensing the initial impedance at a first power-up of the device following manufacture.

10. The method of claim 1, wherein the breach action is selected from the group consisting of issuing an alert to at least one user, securing data stored by the device, and destroying data stored by the device.

11. The method of claim 1, wherein using the swept voltage or the swept current source includes using the swept voltage or the swept current source at a range of frequencies to create an impedance profile of the housing.

12. An apparatus, comprising:
a device configured to be powered, the device including a housing;
a controller;
an impedance sensor controlled by the controller, the impedance sensor configured to measure a measured impedance between a first location of the housing and a second location of the housing; and
a swept current source;
wherein the controller is configured to compare the measured impedance with a predetermined impedance between the first location and the second location;
wherein the controller is configured to initiate a breach action if the measured impedance is not substantially equal to the predetermined impedance; and
wherein the controller is configured to control the impedance sensor to measure the measured impedance at a plurality of frequencies using the swept current source.

13. The apparatus of claim 12, wherein the impedance sensor is a kelvin sensor.

14. The apparatus of claim 12, wherein the impedance sensor includes a friction connector configured to maintain the impedance sensor in place on the housing.

15. The apparatus of claim 12, wherein the friction connector includes a leaf spring or a plurality of pogo pins.

16. The apparatus of claim 12, wherein the device is a mobile device and the housing is a mobile device case.

17. A method, comprising:
providing power to a device including a housing;
determining an initial impedance at a first time between a first location of the housing and a second location of the housing;
measuring a measured impedance at a second time following the first time between the first location of the housing and the second location of the housing;
comparing the measured impedance to the initial impedance; and
initiating a breach action if the measured impedance is not substantially equal to the initial impedance;
wherein a power interruption to the device occurs between the first time and the second time;
wherein measuring the measured impedance includes using a swept AC voltage or a swept AC current source; and
wherein using the swept AC voltage or the swept AC current source includes using the swept AC voltage or the swept AC current source at a range of frequencies to create an impedance profile of the housing.

18. The method of claim 17, wherein measuring the measured impedance includes sensing a property of a coating disposed on the housing.

19. The method of claim 18, wherein the coating is selected from the group consisting of an electromagnetic interference coating and a radio frequency interference coating.

20. The method of claim 17, wherein the breach action is selected from the group consisting of issuing an alert to at least one user of the device, securing data stored by the device, and destroying data stored by the device.
